(19) United States
(12) Patent Application Publication
(10) Pub. No.: US 2021/0395469 A1
(43) Pub. Date: Dec. 23, 2021

(54) COMPOSTABLE MATERIAL FOR PACKAGING

(71) Applicant: Advanced Extrusion, Inc., Rogers, MN (US)

(72) Inventors: John Thibado, Rogers, MN (US); Mathias Weber, Rogers, MN (US)

(21) Appl. No.: 17/291,543

(22) PCT Filed: Nov. 6, 2018
(86) PCT No.: PCT/US2018/059402

§ 371 Date: May 5, 2021

(51) Int. Cl. C08J 3/20; B32B 27/36; B32B 27/20; B32B 7/12; B32B 27/30; B32B 27/08; B65D 65/46; B29C 48/00; B29C 48/08; B29C 48/88; C08K 3/36

(52) U.S. Cl. CPC C08J 3/203; B29K 2067/046; B32B 27/20; B32B 7/12; B32B 27/306; B32B 27/08; B65D 65/466; B29C 48/0017; B29C 48/08; B29C 48/9135; B29C 48/022; C08K 3/36; B32B 2250/05; B32B 2307/7244; B32B 2250/24; B32B 2307/7163; B32B 2307/412; B32B 2307/414; B32B 27/36

(57) ABSTRACT

A compostable material and methods of forming the same are described. The compostable material includes about 90% to about 99% by weight of a compostable polymeric material and a nucleating agent. The compostable material has a degree of crystallinity of about 5% to about 45%.

### TECHNICAL FIELD

This disclosure relates to materials for product packaging, and more specifically, compostable materials for food packaging.

### BACKGROUND

Product packaging, and particularly food packaging, may often include one or more non-compostable materials. In many cases, this is because materials that provide a barrier to keep foods or other products fresh or otherwise sealed from outside contaminants are often non-compostable. For example, single use coffee or drink containers (sometimes called pods) are often composed of petroleum-based polymers, such as styrene, polyethylene, polypropylene, aluminum polymer laminate, and/or other non-compostable materials. Product packaging made of compostable materials can be considered more environmentally friendly than product packaging that includes non-compostable materials.

### SUMMARY

This disclosure describes technologies relating to compostable materials for food packaging. In some examples described herein, food packaging containers can be configured to provide a suitable shelf life of the packaged food while also achieving a generally compostable construction. Optionally, the food packaging container may be constructed of a sheet material having one or more layers in accordance with one or more of the processes described herein. Some embodiments of the technologies described herein may optionally employ compostable material(s) as a food packaging container, which can contribute to environmental benefits, such as a reduction in landfill waste.

Certain aspects of the subject matter described here can be implemented as a compostable material. The compostable material includes about 90% to about 99% by weight of a compostable polymeric material. The compostable material includes a nucleating agent. The compostable material has a degree of crystallinity of about 5% to about 45%.

This, and other aspects, can include one or more of the following features.

One or more crystalline regions of the compostable material can include spherulite structures.

The compostable material can be translucent or transparent.

The compostable polymeric material can be selected from a group consisting of polylactic acid (PLA), polyhydroxyalkanoate (PHA), polybutylene succinate, cellulose, and combinations of these.

The nucleating agent can be selected from a group consisting of ethylene bis-stearamide, an aromatic sulfonate derivative, a talc, and combinations of these.

The weight ratio of the compostable polymeric material to the nucleating agent in the compostable material can be between 15:1 and 50:1.

The compostable material can include about 1% to about 10% by weight of the nucleating agent.

The compostable material can have a degree of crystallinity of about 15% to about 25%.

The compostable material can be substantially free of impact modifier.

The compostable material can be a microwavable material.

The microwavable material can be configured to retain its shape when exposed to a temperature of about 200 degrees Fahrenheit (° F.) to about 250° F.

Certain aspects of the subject matter described here can be implemented as a first method of forming a compostable material. A compostable polymeric material and a nucleating agent are combined to form a mixture. The mixture includes about 90% to about 99% by weight of the compostable polymeric material. The mixture is melted. The molten mixture is extruded into an extrudate. The extrudate is cooled at a predetermined cooling rate to form the compostable material. The predetermined cooling rate is faster than a rate at which the extrudate cools when subjected to room temperature conditions. The compostable material has a degree of crystallinity of about 5% to about 45%.

This, and other aspects, can include one or more of the following features.

The compostable material can be a sheet.

The compostable material can be a tray.

The extrudate can be thermoformed to form the compostable material.

Certain aspects of the subject matter described here can be implemented as a second method of forming a compostable material. A first compostable polymeric material and a nucleating agent are mixed to form a first mixture. The first compostable polymeric material has a degree of crystallinity of greater than 30%. The first mixture and a second compostable polymeric material are mixed to form a second mixture. The second compostable polymeric material has a degree of crystallinity of about 15% to about 45%. The second mixture is melted. The molten second mixture is extruded to form an extrudate. The extrudate is cooled to form the compostable material. The compostable material has a degree of crystallinity of about 5% to about 30%.

This, and other aspects, can include one or more of the following features.

The second compostable polymeric material can have a degree of crystallinity of about 35% to about 45%.

The second compostable polymeric material can have a degree of crystallinity that is greater than the degree of crystallinity of the first compostable polymeric material.

The second compostable polymeric material can include the first compostable polymeric material and the nucleating agent.

The second compostable polymeric material can include an extrudate, a thermoformed material, or combinations of these.

The details of one or more embodiments of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an example compostable material.

FIG. 2 is a schematic diagram of an example system for producing the compostable material of FIG. 1.

FIG. 3 is a flow chart of an example method for using the system of FIG. 2 to produce the compostable material of FIG. 1.

FIG. 4 is a block diagram of an example system for producing the compostable material of FIG. 1.

FIG. 5 is a flow chart of an example method for using the system of FIG. 4 to produce the compostable material of FIG. 1.

FIG. 6 is a plot of data from differential scanning calorimetry (DSC) testing of an example compostable material.

FIG. 7 is a plot of data from DSC testing of an example compostable material.

FIG. 8 is a plot of data from DSC testing of an example compostable material.

### DETAILED DESCRIPTION

This disclosure describes containers that may be generally compostable and may provide for a suitable shelf life, such as food packaging containers that provide a suitable shelf life of the packaged food. For example, in some embodiments, a container of the present disclosure may contain about 90% to about 100% or about 99% to about 100% compostable and/or biodegradable material(s). A compostable or biodegradable material may include an organic or inorganic material configured to chemically or physically break down or decompose under aerobic and/or anaerobic conditions, such as in a municipal or industrial composting or digesting facility. Additionally, or alternatively, a food packaging container of the present disclosure may include one or more generally non-compostable or non-biodegradable materials. In some embodiments, a food packaging container may be constructed of a sheet material having one or more layers. For example, the sheet material may have an internal layer sandwiched between two external layers, and two bonding layers coupling the internal layer with each external layer. In some embodiments, the sheet material may be extruded, co-extruded, or laminated. In some embodiments, the sheet material may be extruded, co-extruded, or laminated using a single screw extruder or a multi-screw extruder (e.g., twin screw extruder). The resulting container may be compostable while still providing a suitable barrier for the packaged food. By providing compostable materials as food packaging containers for particular products, consumers of such products may produce less landfill waste or less harmful waste.

The subject matter described in this disclosure can be implemented in particular embodiments so as to realize one or more of the following advantages. The compostable material can be formed to have improved thermal and mechanical properties. For example, the compostable material can have a suitable degree of crystallinity that allows for the material (for example, in sheet form) to be quickly thermoformed (or another forming, manufacturing, or conversion process). The compostable material can have a heat deflection temperature (HDT) that is higher than the HDT of traditional food packaging material, for example, a HDT that is higher than 140 degrees Fahrenheit (° F.). The compostable material can be microwavable, such that the compostable material can be exposed to microwave energy and retain its thermal and mechanical properties and without deforming. A microwavable material can have a high heat resistance and adequate stiffness at elevated temperatures. Optionally, the outer surface of a container made of a microwaveable material remains sufficiently cool such that the container can be safely handled. The term “high heat resistant” indicates that the material will maintain its structural integrity even when contacted by another material (e.g., food) heated to a temperature of about 200° F.-250° F. In some embodiments, the microwavable material is configured to retain its shape at a temperature of about 200° F. to about 250° F., or 200° F. to about 225° F. In some embodiments, the compostable material is substantially free of impact modifier (for example, does not include an impact modifier) but still has suitable ductility and/or strength. In some embodiments, the compostable material is visually transparent or translucent.

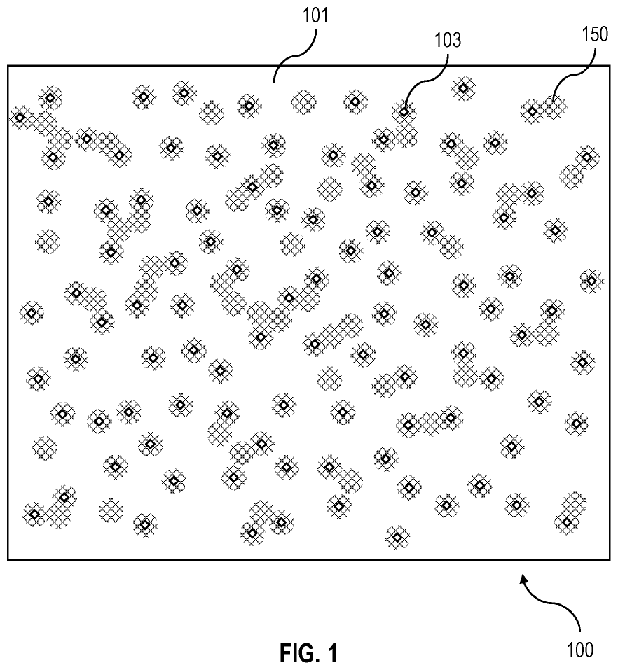

Referring to FIG. 1, a compostable material 100 includes a compostable polymeric material 101 and a nucleating agent 103. The compostable material 100 can have a degree of crystallinity of about 5% to about 40%. In some embodiments, the material 100 has a degree of crystallinity of about 10% to about 35%. In some embodiments, the material 100 has a degree of crystallinity of about 15% to about 30%. In some embodiments, the material 100 has a degree of crystallinity of about 15% to about 25%. The degree of crystallinity of the material 100 affects the thermal and mechanical properties of the material 100. For example, in some embodiments, a degree of crystallinity above 35% crystallinity may prevent the material 100 from being pliable enough for further processing (such as thermoforming), which can be undesirable. In some cases where the degree of crystallinity is too high (for example, above 40%), the material 100 must be re-melted and re-processed, which can be undesirable. In some cases, a degree of crystallinity below 10% crystallinity may require long processing times (for example, for thermoforming) in order to produce a suitable finished product, such as a compostable food packaging container. Long processing times can be undesirable with respect to manufacturability. In some embodiments, the compostable material 100 provides an intermediate product that can readily become a microwavable material following one or more additional heating process, e.g., a theromforming process, as discussed in subsequent sections. In some embodiments, the compostable material 100 can undergo one or more additional heating processes (for example, thermoforming) to produce a microwavable product. For example, after thermoforming, the compostable material 100 can have a degree of crystallinity that is sufficiently high (for example, at least about 35%) for the compostable material 100 to be microwavable.

The degree of crystallinity of the material 100 can be roughly characterized by the portion of the material 100 in which the compostable polymeric material 101 has crystallized in comparison to the entire material 100. FIG. 1 schematically represents the crystallized portions 150 of the material 100. The compostable polymeric material 101 can in some cases crystallize on its own during cooling, so some of the crystallized portions 150 are in regions of the material 100 without the nucleating agent 103. The presence of the nucleating agent 103 can accelerate crystallization, so some of the crystallized portions 150 are localized near the nucleating agent 103 in the material 100. The crystallized portions 150 of the material 100 can include spherulite structures, which can be formed by a controlled crystallization (cooling) process.

The degree of crystallinity of the material 100 can be calculated as % crystallinity by Equation 1:

$$\% crystallinity = \frac{Δ {H}_{m} - Δ {H}_{cc}}{Δ {H}_{c}} \qquad ( 1 )$$

where ΔHₘ is the enthalpy of melting, ΔH_{cc} is the enthalpy of cold crystallinity, and ΔH_{c} is the theoretical enthalpy of melting. The enthalpy of melting (ΔHₘ) and the enthalpy of cold crystallinity (Δ_{cc}) can be determined by differential scanning calorimetry (DSC), and the theoretical enthalpy of melting (ΔH_{c}) should be known about the compostable polymeric material 101 used (or may otherwise be obtained, for example, from a product technical sheet or chemical database).

The following few paragraphs briefly describe an example DSC test that can be followed to calculate the degree of crystallinity of the material 100 according to Equation 1. The values (for example, for time durations, temperatures, and rates) may be adjusted according to the compostable polymeric material 101 used. Although some specific equipment is disclosed in relation to the example DSC test, other similar equipment can be used to carry out the sampling and testing to arrive at similar results. The sample of the compostable material 100 can be cleaned (for example, to remove dust such that the sheet or sample is substantially free of dust). It is desirable to limit handling of the sample of the material 100 to a minimum to limit the chances of contaminating the sample. A test sample (for example, having a size of a postage stamp) can be cut from the sample of material 100 (for example, with a knife or scissors). If desired, a smaller test sample (for example, having the shape of a square with a side dimension that is slightly smaller than the diameter of a pencil) can be cut from the test sample, and the smaller test sample can be DSC tested. In the event that the first DSC test fails or is compromised, another smaller test sample can be cut from the test sample. The corners of the test sample (or smaller test sample) can be cut, such that the shape of the test sample resembles an octagon. The test sample is weighed, and the weight is recorded. The test sample is then placed and centered inside a pan, and a lid is used to secure the test sample within the pan. For example, the lid can be placed in the pan, and a crimper handle can be pressed, such that the edges of the pan crimp over the edges of the lid. The test sample within the closed pan can then be placed in the differential scanning calorimeter for DSC testing.

The internal temperature and pressure of the DSC testing chamber can be adjusted in preparation of the test. For example, the DSC can include an IntraCooler with a standard operating temperature of −86° F. and a nitrogen source for adjusting pressure. The nitrogen source can introduce nitrogen into the DSC testing chamber to adjust the internal pressure to, for example, 30 pounds per square inch gauge (psig). The DSC can be controlled through DSC software (for example, Perkin Elmer “Pyris” software). Before the test sample is placed within the DSC, an initial conditioning process can be implemented for the purpose of evaporating any lingering water content from the DSC testing chamber. After initial conditioning, the test pan (the pan with the test sample) can be placed within the DSC testing chamber. A reference pan (an empty pan including a lid, without any sample inside) can also be placed within the DSC testing chamber. In some cases, it can be desirable for the test pan and the reference pan to be spaced apart from one another (for example, the centers of the test pan and the reference pan can be spaced apart 9/16^{th} of an inch from each other) and centered along an axis of the DSC testing chamber. Relevant information can be entered into the software specific to the test sample (for example, test sample identification name or number, tester, and test sample weight).

The DSC test can then be initiated. According to an example test, the material 100 is held for 1 minute at 0 degrees Celsius (° C.). In a first ramp up cycle, the material 100 is heated from 0° C. to 210° C. at a temperature change rate of 10° C. per minute. The material 100 is held for 1 minute at 210° C. In a cooling cycle, the material 100 is cooled from 210° C. to 0° C. at a temperature change rate of −10° C. per minute. The material 100 is held for 1 minute at 0° C. In a second ramp up cycle, the material is reheated from 0° C. to 210° C. at a temperature change rate of 10° C. per minute. As mentioned previously, the time durations, temperatures, and temperature change rates can be adjusted depending on the compostable polymeric material 101 present in the material 100 being tested. The first ramp up cycle, cooling cycle, and the second ramp up cycle (which is sometimes referred as heating-cooling-heating) can be used to eliminate the thermal history of the sample and to check the production process of the sample. During the second ramp up cycle, the content of amorphous material can be lower and the crystalline content larger in comparison to the first ramp up cycle.

The results of the DSC test are saved and can be analyzed. Plot graphs of the data obtained from the DSC test can be generated, for example, a plot of heat flow vs. temperature. The area under the generated curve on the plot can be used to calculate the some of the enthalpy values in Equation 1. For example, the enthalpy of cold crystallinity, ΔH_{cc}, and the enthalpy of melting, can be determined from the first ramp up cycle. With the theoretical enthalpy of melting (ΔH_{c}) known, Equation 1 can be used to determine the degree of crystallinity of the material 100.

The compostable polymeric material 101 can include one or more polymeric materials that are compostable in accordance with American Society for Testing and Materials (ASTM) Standard D6400. Some non-limiting examples of a suitable compostable polymeric material 101 are polylactic acid (PLA), polyhydroxyalkanoate (PHA), polybutylene succinate, and cellulose. The compostable polymeric material 101 can include one or more crystalline PLA materials (cPLA), which may include PLA crystallized during extrusion, thermoforming, or another sheeting, forming, manufacturing, or conversion process. The cPLA may be crystallized to achieve a desired minimum heat deflection temperature and/or operating temperature. For example, in some embodiments, PLA may be crystallized to achieve a minimum HDT of about 150° F. to about 300° F. In some embodiments, the PLA may be crystallized to achieve a minimum HDT of about 150° F. to about 250° F. In some embodiments, the PLA may be crystallized to achieve a minimum HDT of about 175° F. to about 225° F. In some embodiments, the PLA may be crystallized to achieve a minimum HDT of about 186° F. to about 211° F. In some embodiments, the cPLA minimum heat deflection may be achieved, determined, or tested in accordance with ASTM Standard D648. The desired minimum HDT for cPLA may be determined based on a desired operating temperature. For example, the PLA may be crystallized to achieve workability without deformation at an operating temperature of about 140° F. to about 240° F. In some embodiments, the PLA may be crystallized to achieve workability without deformation at an operating temperature of about 170° F. to about 210° F. In some embodiments, the PLA may be crystallized to achieve workability without deformation at an operating temperature of about 180° F. to about 200° F.

The nucleating agent 103 can include one or more components or materials configured to accelerate the crystallization of a crystalline or semi-crystalline polymer. The nucleating agent 103 can accelerate the crystallization of the compostable polymeric material 101 (for example, PLA). The nucleating agent 103 can be compostable or non-compostable. Some non-limiting examples of a suitable compostable nucleating agent 103 are ethylene bis-stearamide, aromatic sulfonate derivative, and talc. In some embodiments, each of the one or more nucleating agents 103 within the material 100 are compostable nucleating agents.

Various amounts of the compostable polymeric material 101 in comparison to the nucleating agent 103 can be present in the material 100. The material 100 can include at least 70% by weight of the compostable polymeric material 101. In some embodiments, the material 100 includes about 90% to about 99% by weight of the compostable polymeric material 101. In some embodiments, the material 100 includes about 92% to about 97% by weight of the compostable polymeric material 101. In some embodiments, the material 100 includes about 93% to about 95% by weight of the compostable polymeric material 101. For example, the material 100 includes 93%, 94%, or 95% by weight of the compostable polymeric material 101. The material 100 can include at least 1% by weight of the nucleating agent 103. In some embodiments, the material 100 includes about 1% to about 10% by weight of the nucleating agent 103. In some embodiments, the material 100 includes about 1% to about 6% by weight of the nucleating agent 103. In some embodiments, the material 100 includes about 2% to about 5% by weight of the nucleating agent 103. For example, the material 100 includes 4% or 5% by weight of the nucleating agent 103.

In some embodiments, a weight ratio of the compostable polymeric material 101 to the nucleating agent 103 in the compostable material 100 is between 15:1 and 50:1. In some embodiments, a weight ratio of the compostable polymeric material 101 to the nucleating agent 103 in the compostable material 100 is between 15:1 and 30:1. In some embodiments, a weight ratio of the compostable polymeric material 101 to the nucleating agent 103 in the compostable material 100 is between 15:1 and 25:1. For example, the material 100 includes 93% by weight of the compostable polymeric material 101 and 2% by weight of the nucleating agent 103 (translating to a weight ratio of 93:2). For example, the material 100 includes 94% by weight of the compostable polymeric material 101 and 4% by weight of the nucleating agent 103 (translating to a weight ratio of 47:2). For example, the material 100 includes 95% by weight of the compostable polymeric material 101 and 5% by weight of the nucleating agent 103 (translating to a weight ratio of 19:1).

Additionally, or alternatively, the material 100 can include one or more other compostable or non-compostable additives or other materials. For example, in some embodiments, the material 100 includes a pigment for affecting the color of the material 100. In some embodiments, the material 100 includes less than 1% to about 10% by weight of one or more pigments or other additives. In some embodiments, the material 100 includes less than 1% to about 5% of one or more pigments or other additives. In some embodiments, the material 100 includes about 0.01% to about 1% of one or more pigments or other additives. In some embodiments, each of the one or more additive materials within the material 100 are compostable additive materials. In some embodiments, the material 100 does not include pigment for affecting the color of the material 100, and the material 100 is translucent or transparent (that is, allows light to pass through the material 100).

In some embodiments, the material 100 can optionally include one or more oxygen barrier materials. An oxygen barrier material can be a component or material configured to improve (that is, decrease) an oxygen transmission rate (OTR) of the container. By decreasing the OTR of a food packaging container, the one or more oxygen barrier materials can increase the ability of the material 100 to maintain food freshness, shelf life, or longevity. An oxygen barrier material can be compostable or non-compostable. Some non-limiting examples of a suitable compostable oxygen barrier material include ethylene vinyl alcohol (EVOH), polyglutamic acid, and polyglycolic acid. In some embodiments, the oxygen barrier material includes an extrusion grade vinyl alcohol. In some embodiments, the oxygen barrier material includes an alcohol copolymer, alcohol, and acetate. For example, the oxygen barrier material can include butenediol-vinyl-alcohol copolymer, methanol, and methyl acetate (such as G polymer OKS-8049P). In some embodiments, the material 100 includes about 1% to about 50% by weight of one or more oxygen barrier materials, which may include one or more compostable oxygen barrier materials. In some embodiments, the material 100 includes about 2.5% to about 32.5% of one or more oxygen barrier materials, which may include one or more compostable oxygen barrier materials. In some embodiments, the material 100 includes about 5% to about 15% of one or more oxygen barrier materials, which may include one or more compostable oxygen barrier materials. In some embodiments, each of the one or more oxygen barrier materials within the material 100 are compostable oxygen barrier materials.

An impact modifier can be a component or material configured to increase the ductility and/or impact strength of a material (such as the material 100). An impact modifier can be compostable or non-compostable. Some non-limiting examples of a compostable impact modifier are acetic acid ethenyl ester, homopolymer, copolymer, and vinyl acetate homopolymer. In some embodiments, the material 100 is substantially free of impact modifier.

The material 100 can be formed by extrusion. In some embodiments, heat is applied in the extrusion process, such that the material 100 is melted and extruded. To form the material 100, a mixture of the compostable polymeric material 101 and the nucleating agent 103 (and any additives) can be heated above its glass transition temperature. In some embodiments, to form the material 100, a mixture of the compostable polymeric material 101 and the nucleating agent 103 (and any additives) is heated above its melting temperature. The nucleating agent 103 present in the material 100 can accelerate the crystallization of the material 100. The material 100 can then be cooled in a controlled cooling process, such that the crystallization of the material 100 involves forming spherulite structures within the material 100. Once a desired degree of crystallinity of the material 100 is achieved (for example, about 5% to about 40% crystallinity), the material 100 can be rapidly cooled to stop the crystallization of the material 100. As mentioned before, a degree of crystallinity of the material 100 that is too low or too high can result in sub-optimal thermal and/or mechanical properties of the material 100.

In some embodiments, the compostable material 100 is an intermediate product that can be subject to further processing (for example, thermoforming). The degree of crystallinity (or range of crystallinity) achieved in the material 100 can therefore be controlled to facilitate such subsequent processing of the material 100 and to achieve the desired characteristics (such as thermal properties) in the finalized form of the material 100 (for example, after the one or more subsequent processing). In some embodiments, the degree of crystallinity of the material 100 is sufficiently low to promote manufacturability and formability of the material 100 in subsequent processing steps, such as a thermoforming step. In some embodiments, the degree of crystallinity of the material 100 is sufficiently high, such that the desired degree of crystallinity of the material 100 in its finalized form after one or more subsequent processing steps can be achieved quickly with the one or more subsequent processing steps. The desired degree of crystallinity of the material 100 in its finalized form can be chosen based on one or more desired characteristics of the material 100, for example, microwavability and structural integrity. In some embodiments, the compostable material 100 as an intermediate product has a degree of crystallinity that is not sufficiently high to achieve the characteristic of microwavability (for example, a degree of crystallinity of less than 25%), but can achieve the characteristic of microwavability after subsequent processing (such as thermoforming) that increases its degree of crystallinity (for example, a degree of crystallinity of about 35% to about 45%). In some embodiments, the compostable material 100 as an intermediate product has a degree of crystallinity that is sufficiently high to achieve the characteristic of microwavability (for example, a degree of crystallinity of about 25% to about 35%) and the higher degree of crystallinity (in comparison to material 100 without the characteristic of microwavability) can reduce subsequent processing times (for example, by about 30% to about 75%) in forming the finalized form of the material 100.

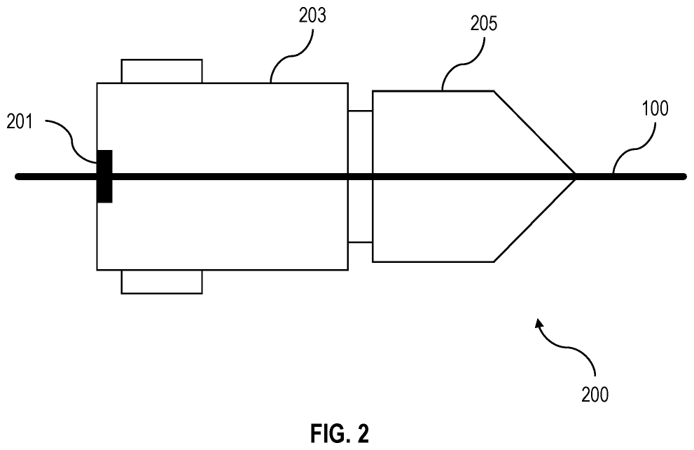

FIG. 2 illustrates an example system 200 for producing a sheet of the material 100. The sheet of the material 100 can be formed by any one or more suitable processes. In some embodiments, the sheet material is formed by extrusion or co-extrusion. In some embodiments, the sheet material is formed by a lamination process. The system 200 includes an extruder 201. Although shown in FIG. 2 as one extruder 201, the system 200 can include additional extruders 201. The one or more extruders 201 can be configured to extrude one or more molten layers of the material 100, for example, two layers, three layers, four layers, five layers, or more than five layers. The one or more extruders 201 can be configured to minimize sharp bends or hang up areas in the melt flow of the material 100. Each extruder 201 can be brought to a desired operating temperature. For example, each extruder 201 can be brought to an operating temperature of about 300° F. to about 500° F.

In some embodiments, one or more of the extruders 201 can heat the material 100 using one or more heaters. For example, one or more of the extruders 201 can include one or more heating zones arranged along a barrel length of the extruder 201. Each of the one or more heating zones can span a particular length along the barrel length of the respective extruder 201 and can include a heater configured to heat material(s) (such as the material 100) within the respective extruder 201 to a desired temperature or temperature range. Each of the one or more heating zones can be configured to heat material(s) to the same desired temperature or temperature range or different desired temperatures or temperature ranges. In each of the one or more extruders 201, the one or more heating zones can allow for gradual heating of the material(s) within the respective extruder 201. The heating zones allow for parallel and serial heating of the material(s): parallel across the one or more extruders 201, and serial within each respective extruder 201. Together, the heating zones can be configured to heat the material(s) within the one or more extruders 201 to a molten state without degrading the material(s). Degradation may occur, for example, as a result of frictional heat caused by overheating of the material(s). By minimizing degradation, the material(s) within the one or more extruders 201 can achieve a stable molten state.

In some embodiments, the one or more extruders 201 can be initiated at different times. For example, the melt flow of a first extruder can be initiated, and once flow from the first extruder is generally thermally stable, the melt flow of a second extruder can be initiated. Timing one or more extruders 201 in this way, such that general thermal stability can be achieved in one extruder 201 before initiating another extruder 201, can provide for reduced scrap and/or waste materials.

The system 200 can include a feed block 203 and a die 205. The feed block 203 can collect the material(s) extruded from the one or more extruders 201 and direct them toward the die 205. In some embodiments, the feed block 203 arranges the material(s) extruded from the one or more extruders 201 into layers, for example, two layers, three layers, four layers, five layers, or more than five layers. In such cases, the feed block 203 can converge the layers and direct them toward the die 205. The die 205 can generally compress and/or shape the extruded material(s) into sheet form.

The system 200 can include one or more cooling rolls (not shown). For example, the system 200 can include several cooling rolls in series. The one or more cooling rolls can cool the material 100 using one or more coolers. For example, each of the one or more cooling rolls can include a cooler configured to cool material(s) (such as the material 100) passing through the respective cooling roll to a desired temperature or temperature range. Each of the one or more cooling rolls can be configured to cool material(s) to the same desired temperature or temperature range or different desired temperatures or temperature ranges. Cooling the material 100 can cause portions of the material 100 to crystallize. The nucleating agent 103 present in the material 100 can act as seeds for the crystallization of the compostable polymeric material 101 and therefore accelerate the crystallization process of the material 100. The one or more cooling rolls can allow for gradual cooling of the material(s). Together, the cooling rolls can be configured to cool the material(s) in a gradual manner, such that spherulite structures are formed as the material 100 crystallizes.

The system 200 can include a quencher (not shown). Once a desired degree of crystallinity of the material 100 is achieved using the one or more cooling rolls, the quencher can be used to rapidly cool the material 100 and stop the crystallization process. For example, the quencher can be a cooled water bath within which the material 100 can be submerged.

The compostable material 100 can be provided in sheet form. In some cases, the compostable material 100 is provided in the form of a roll. The system 200 can include one or more rollers (not shown). For example, the system 200 can include several rollers in series. The one or more rollers can roll the sheet of material 100 into a roll.

The material 100, or a portion thereof, can be formed of a single structural component. In some embodiments, the material 100, or a portion thereof, can be formed into a single structural component. For example, the material 100 can be thermoformed or vacuum-formed from one or more sheets of the material 100 to form a food packaging container having a single structural component. The additional processing (for example, thermoforming) can cause the material 100 to further crystallize (that is, the degree of crystallization of the material 100 can be increased by the additional processing). In some embodiments, the degree of crystallization of the material 100 in its final product form (for example, as a compostable food packaging container) is about 35% to about 45% crystallinity. In some embodiments, the material 100 can be formed by injection molding or other suitable methods.

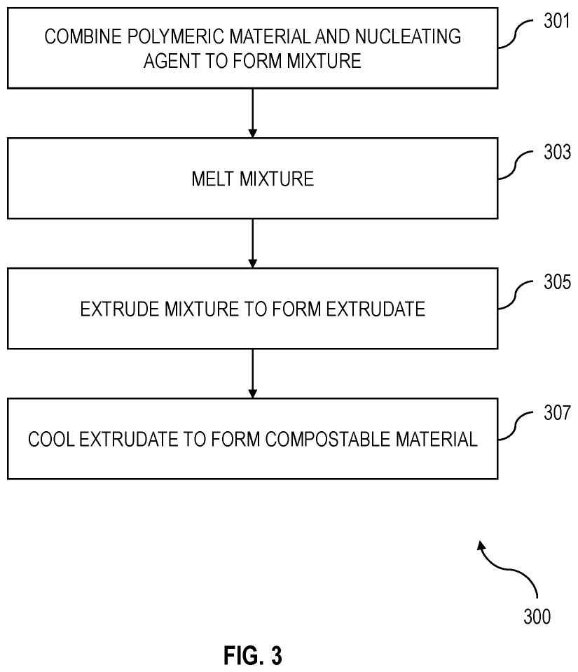

FIG. 3 is a flow chart for a method 300 for using the system 200 to produce the compostable material 100. At step 301, a compostable polymeric material (such as the compostable polymeric material 101) and a nucleating agent (such as the nucleating agent 103) are combined to form a mixture. The mixture can have any one of the compositions for the compostable material 100 described previously (with respect to FIG. 1). For example, the mixture can include about 90% to about 99% by weight of the compostable polymeric material 101. In some embodiments, the compostable polymeric material 101 and the to nucleating agent 103 are in solid form and mechanically mixed. For example, the compostable polymeric material 101 can be in the form of pellets, and the nucleating agent 103 can be in the form of a powder.

At step 303, the mixture is melted, and at step 305 the molten mixture is extruded to form an extrudate. In some embodiments, steps 303 and 305 can occur at the same time. For example, as previously described with respect to FIG. 2, the system 200 can include one or more extruders 201, and each of the one or more extruders 201 can include one or more heating zones (with respective heaters). Using the system 200, the mixture can be melted and extruded at the same time. In some embodiments, step 303 occurs before step 305 (that is, the mixture is melted, and then the molten mixture is extruded to form the extrudate). Extruding the molten mixture at step 305 can include using the feed block 203 and the die 205 to form the extrudate.

At step 307, the extrudate is cooled at a predetermined cooling rate to form the compostable material 100. The predetermined cooling rate is faster than a rate at which the extrudate cools when subjected to room temperature conditions. The cooling at the predetermined cooling rate can include passing the extrudate through one or more cooling rolls (such as the series of cooling rolls described previously with respect to system 200). Cooling the extrudate at the predetermined cooling rate can cause the formation of spherulite structures in the material 100. The presence of the nucleating agent 103 in the material 100 can also facilitate the crystallization of the compostable polymeric material 101 at step 307. The crystallization process can be stopped once the material 100 has achieved a desired degree of crystallinity (for example, once the material 100 has a degree of crystallinity of about 5% to about 40%). Stopping the crystallization process can include rapidly cooling the extrudate using, for example, a quencher (such as the quencher described previously with respect to system 200).

In some embodiments, the compostable material 100 formed at step 307 is in the form of a sheet. In some embodiments, the compostable material 100 formed at step 307 is in the form of a tray. In some embodiments, step 307 can include thermoforming the extrudate to form the compostable material 100.

Keeping all other conditions the same, if method 300 is carried out excluding the nucleating agent 103, a compostable material can still be produced, but the resulting compostable material would have a degree of crystallinity that is less than the degree of crystallinity of the material 100 formed with the nucleating agent 103. For example, the compostable material produced by carrying out method 300 excluding the nucleating agent 103 has a degree of crystallinity of less than about 5%, less than about 10%, or less than about 15%.

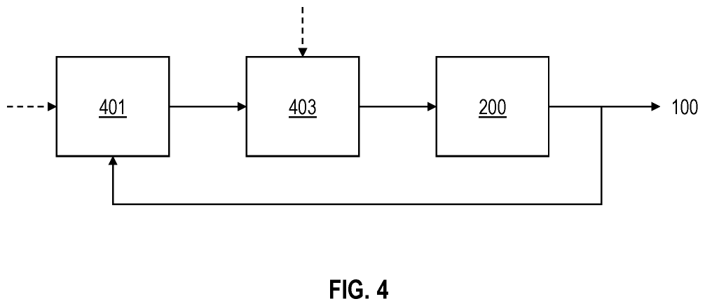

FIG. 4 illustrates an example system 400 for producing a sheet of the material 100. The system 400 can include a crystallizer 401, a dryer 403, and an extrusion system (such as the system 200). The crystallizer 401 can include one or more components, for example, a mixer, a heater, and a blower. Within the crystallizer 401, material can be agitated and heated in preparation for the dryer 403. For example, material can be processed within the crystallizer 401, such that the material exiting the crystallizer 401 has adequate thermal stability to be able to withstand the operating temperature of the dryer 403. In some embodiments, the blower introduces hot air at the bottom of the crystallizer 401, and the hot air exits at the top of the crystallizer 401. Material from the crystallizer 401 can be transported (for example, by a conveyor) to the dryer 403. The dryer 403 can include one or more components, for example, a heater, a mixer, and a vacuum system. Within the dryer 403, material can be dried, for example, by heating and removing any evaporated moisture. In some embodiments, the dryer 403 includes a desiccant, which can absorb moisture. In some embodiments, the dryer 403 includes a blower that circulates air through the dryer 403, and the desiccant can absorb moisture from the air within the dryer 403. In some embodiments, the material exiting the dryer 403 has a moisture (water) content of less than 100 parts per million (ppm). Material from the dryer 403 can be transported (for example, by a conveyor) to the extrusion system 200. The system 400 is configured to produce the compostable material 100. For example, the material exiting the extrusion system 200 is that compostable material 100.

As shown in FIG. 4, a portion of the compostable material 100 exiting the extrusion system 200 can be recycled to the crystallizer 401. In some embodiments, other compostable material (for example, compostable material supplied by others) can also be introduced to the crystallizer 401. Raw material (for example, the compostable polymeric material 101 and/or the nucleating agent 103) can be introduced to the dryer 403 in addition to the material from the crystallizer 401.

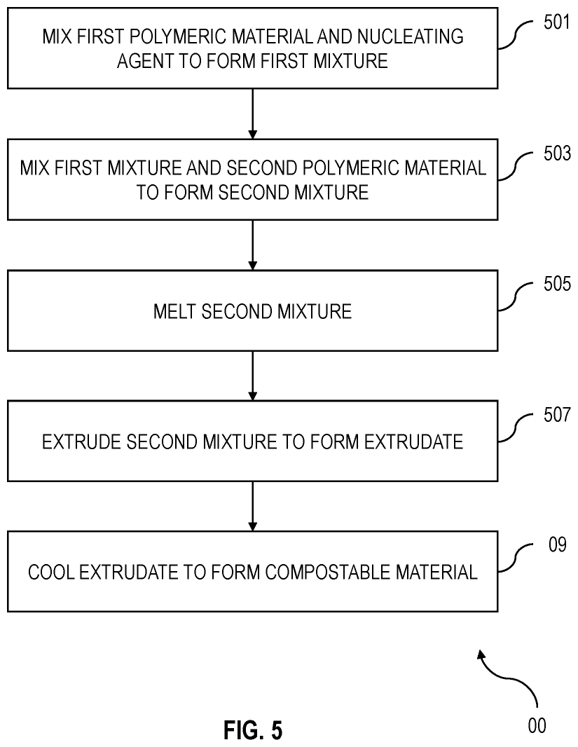

FIG. 5 is a flow chart for a method 500 for producing the compostable material 100. A variation of the system 200 can also be used to carry out the method 500. For example, system 400 (which includes system 200) can be used to carry out the method 500. At step 501, a first compostable polymeric material (such as the compostable polymeric material 101) and a nucleating agent (such as the nucleating agent 103) is mixed to form a first mixture. The first compostable polymeric material can have a degree of crystallinity of greater than 30%. In some embodiments, the first compostable polymeric material has a degree of crystallinity of about 35% to about 45%.

At step 503, the first mixture is mixed with a second compostable polymeric material to form a second mixture. The second compostable polymeric material has a degree of crystallinity of about 5% to about 45%. The first mixture can be mixed with the second compostable polymeric material to form the second mixture at step 503, for example, using the dryer 403. The second compostable polymeric material can include an extrudate, a thermoformed material, or a combination of these. In some embodiments, the second compostable polymeric material is a compostable material (such as the material 100) formed according to the method 300 (steps 301, 303, 305, and 307) described previously. In some embodiments, the second compostable polymeric material has a degree of crystallinity that is greater than the degree of crystallinity of the compostable material 100 formed according to method 100. In some embodiments, the second compostable polymeric material has a degree of crystallinity that is greater than the degree of crystallinity of the first compostable polymeric material. In some embodiments, the second compostable polymeric material is excess material 100 (for example, trim that is not provided to a customer). In such cases, the excess material 100 can be recycled and provided as the second compostable polymeric material to produce additional compostable material 100. In some embodiments, the excess material 100 is crystallized in the crystallizer 401 before being mixed with the first mixture at step 503.

In some embodiments, the second compostable polymeric material includes the same first compostable polymeric material from step 501. In some embodiments, the second compostable polymeric material includes the nucleating agent. A ratio of the first compostable polymeric material and the nucleating agent in the second compostable polymeric material can be substantially the same as or different from a ratio of the first compostable polymeric material and the nucleating agent in the first mixture. A ratio of the first compostable polymeric material and the nucleating agent in the second mixture can be substantially the same as or different from the ratio of the first compostable polymeric material and the nucleating agent in the first mixture. The composition of the second mixture can be substantially the same as or different from the composition of the first mixture.

In some embodiments, the second compostable polymeric material is ground and broken apart before the second compostable polymeric material is mixed with the first mixture. In this disclosure, the terms “grind” and “break apart” (and their various forms) should be interpreted in a flexible manner to include any form of reducing a substance into smaller pieces, such as break apart or shear, and does not necessarily mean, for example, that the substance is pulverized into a powder.

Steps 505, 507, and 509 are substantially similar to steps 303, 305, and 307, respectively, of method 300. At step 505, the second mixture is melted. At step 507, the molten second mixture is extruded to form an extrudate. Similar to steps 303 and 305, steps 505 and 507 can occur at the same time. At step 509, the extrudate is cooled to form the compostable material 100. In some embodiments, the compostable material 100 is also thermoformed. The compostable material 100 can have a degree of crystallinity of about 5% to about 30% (for example, a degree of crystallinity of about 5%, about 10%, about 15%, about 20%, about 25%, or about 30%). In some embodiments, the compostable material 100 can have a degree of crystallinity of up to about 45%.

### EXAMPLES

The following examples are illustrative sheet materials having one or more layers and having desirable thermal and mechanical properties for a compostable food packaging container.

### Example 1: Single Layer Sheet of Compostable Material

TABLE 1

| | % by Weight | | | % by Weight |
|---|---|---|---|---|
| Layer | of Sheet | Material | Name | of Layer |
| 1 | 100% | cPLA | Natureworks Ingeo | 90-98% |
| | | | Biopolymer 4032D | |
| | | Nucleating | Cimbar FlexTalc 610 | 1-10% |
| | | Agent | | |
| | | Pigment | Brown, Dark Brown, | 1-5% |
| | | | White, Beige, Black, | |
| | | | Dark Green (or other | |
| | | | suitable color) | |

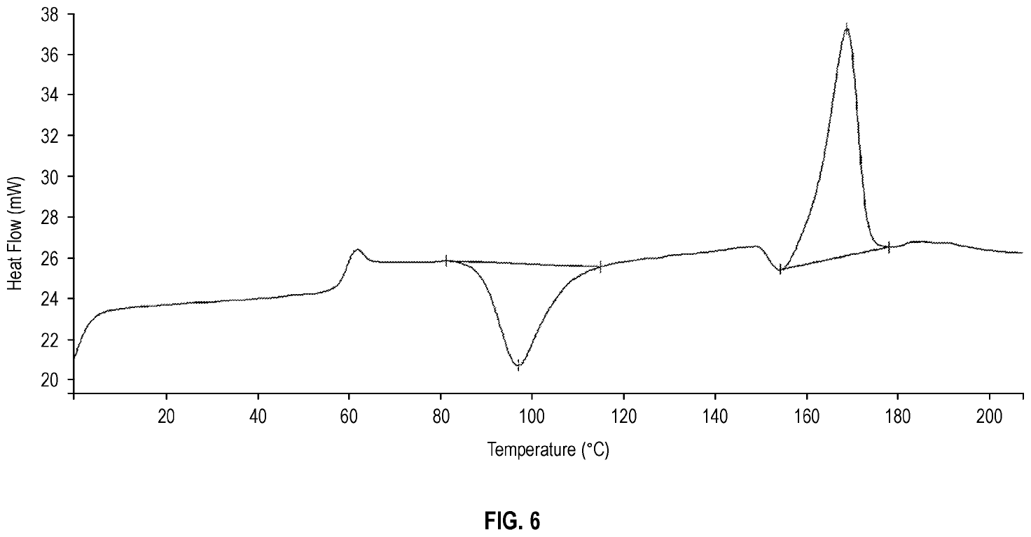

FIG. 6 is a plot of a first ramp up cycle of a DSC test for determining the degree of crystallinity of a sample having the composition provided in Table 1. The first peak (with a local minimum occurring at about 97° C.) was attributed to the cold crystallinity of the sample. By calculating the area under the first peak and dividing the area by the mass of the sample, the enthalpy of cold crystallinity (ΔH_{cc}) was calculated to be 20.45 Joules per gram (J/g). The second peak (with a local maximum occurring at about 169° C.) was attributed to the melting of the sample. By calculating the area under the second peak and dividing the area by the mass of the sample, the enthalpy of melting (ΔHₘ) was calculated to be 31.70 J/g. The theoretical enthalpy of melting (ΔH_{c}) of the cPLA was known to be 93.7 J/g. Inputting these enthalpy values into Equation 1, the degree of crystallinity of the sample in Example 1 was determined to be 12.0%.

### Example 2: Single Layer, Clear Sheet of Compos Table Material

TABLE 2

| | % by Weight | | | % by Weight |
|---|---|---|---|---|
| Layer | of Sheet | Material | Name | of Layer |
| 1 | 100% | cPLA | Natureworks Ingeo | 90-99% |
| | | | Biopolymer 4032D | |
| | | Nucleating | Sukano na S516 | 1-10% |
| | | Agent | | |

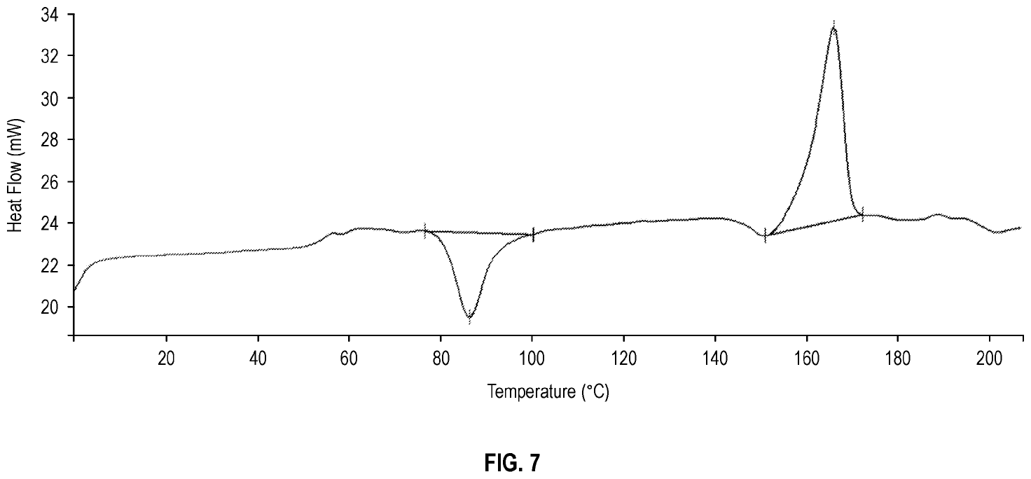

FIG. 7 is a plot of a first ramp up cycle of a DSC test for determining the degree of crystallinity of a sample having the composition provided in Table 2. The first peak (with a local minimum occurring at about 87° C.) was attributed to the cold crystallinity of the sample. By calculating the area under the first peak and dividing the area by the mass of the sample, the enthalpy of cold crystallinity (ΔH_{cc}) was calculated to be 19.79 J/g. The second peak (with a local maximum occurring at about 166° C.) was attributed to the melting of the sample. By calculating the area under the second peak and dividing the area by the mass of the sample, the enthalpy of melting (ΔHₘ) was calculated to be 41.62 J/g. The theoretical enthalpy of melting (ΔH_{c}) of the cPLA was known to be 93.7 J/g. Inputting these enthalpy values into Equation 1, the degree of crystallinity of the sample in Example 2 was determined to be 23.3%.

### Example 3: Multi-Layer Sheet of Compostable Material with Oxygen Barrier

TABLE 3

| | % by Weight | | | % by Weight |
|---|---|---|---|---|
| Layer | of Sheet | Material | Name | of Layer |
| 1 & 5 | 89% | cPLA | Natureworks Ingeo | 90-98% |
| (outer) | | | Biopolymer 4032D | |
| | | Nucleating | Cimbar FlexTalc | 1-9% |
| | | Agent | 610 | |
| | | Pigment | Brown, Dark Brown, | 1-5% |
| | | | White, Beige, Black, | |
| | | | Dark Green (or other | |
| | | | suitable color) | |
| 2 & 4 | 4% | Adhesive | Nippon Gohsei | 95-100% |
| | | | BTR8002P | |
| 3 | 7% | Oxygen | Nippon Gohsei | 95-100% |
| (core) | | Barrier | Nichigo G-Polymer | |
| | | | OKS-8049P | |

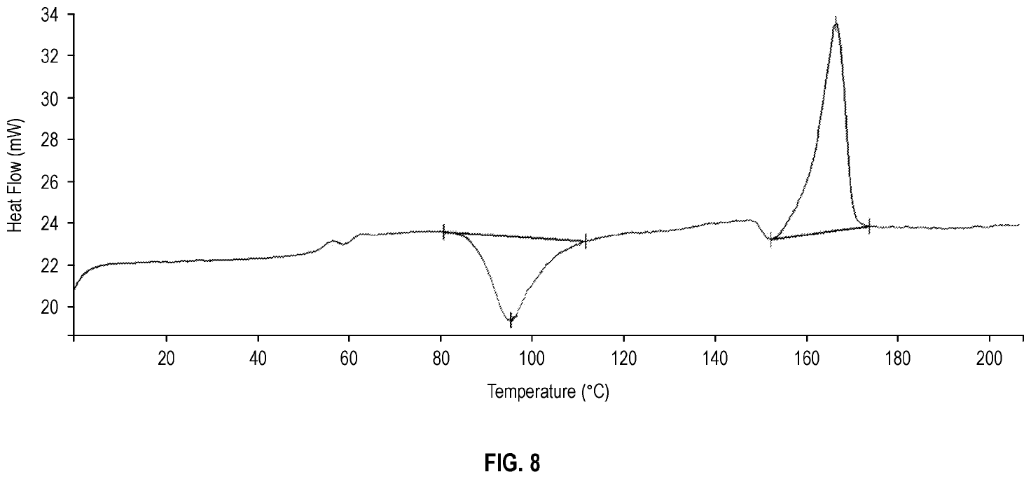

FIG. 8 is a plot of a first ramp up cycle of a DSC test for determining the degree of crystallinity of a sample having the composition provided in Table 3. The first peak (with a local minimum occurring at about 96° C.) was attributed to the cold crystallinity of the sample. By calculating the area under the first peak and dividing the area by the mass of the sample, the enthalpy of cold crystallinity (ΔH_{cc}) was calculated to be 24.12 J/g. The second peak (with a local maximum occurring at about 167° C.) was attributed to the melting of the sample. By calculating the area under the second peak and dividing the area by the mass of the sample, the enthalpy of melting (ΔHₘ) was calculated to be 37.76 J/g. The theoretical enthalpy of melting (ΔH_{c}) of the cPLA was known to be 93.7 J/g. Inputting these enthalpy values into Equation 1, the degree of crystallinity of the sample in Example 3 was determined to be 14.6%.

In this disclosure, the term “about” (with respect to quantities or values) means a deviation or allowance of up to 10 percent (%) and any variation from a mentioned value is within the tolerance limits of any machinery used to manufacture the part.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise. “About” can allow for a degree of variability in a value or range, for example, within 10%, within 5%, or within 1% of a stated value or of a stated limit of a range.

While this disclosure contains many specific embodiment details, these should not be construed as limitations on the subject matter or on what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Nevertheless, it will be understood that various modifications, substitutions, and alterations may be made. While operations are depicted in the drawings or claims in a particular order, this should not be understood as requiring that such operations be performed in the particular order shown or in sequential order, or that all illustrated operations be performed (some operations may be considered optional), to achieve desirable results. Accordingly, the previously described example embodiments do not define or constrain this disclosure.

1. A compostable material comprising:
about 90% to about 99% by weight of a compostable polymeric material; and
a nucleating agent,
wherein the compostable material has a degree of crystallinity of about 5% to about 45%.

2. The compostable material of claim 1, wherein one or more crystalline regions of the compostable material comprise a plurality of spherulite structures.

3. The compostable material of claim 1, wherein the compostable material is translucent or transparent.

4. The compostable material of claim 1, wherein the compostable polymeric material is selected from a group consisting of polylactic acid (PLA), polyhydroxyalkanoate (PHA), polybutylene succinate, cellulose, and combinations thereof.

5. The compostable material of claim 1, wherein the nucleating agent is selected from a group consisting of ethylene bis-stearamide, an aromatic sulfonate derivative, a talc, and combinations thereof.

6. The compostable material of claim 1, wherein the weight ratio of the compostable polymeric material to the nucleating agent in the compostable material is between 15:1 and 50:1.

7. The compostable material of claim 1, wherein the compostable material comprises about 1% to about 10% by weight of the nucleating agent.

8. The compostable material of claim 1, wherein the compostable material has a degree of crystallinity of about 15% to about 25%.

9. The compostable material of claim 1, wherein the compostable material is substantially free of impact modifier.

10. The compostable material of claim 1, wherein the compostable material is a microwavable material.

11. The compostable material of claim 10, wherein the microwavable material is configured to retain its shape when exposed to a temperature of about 200° F. to about 250° F.

12. A method of forming a compostable material, comprising:
combining a compostable polymeric material and a nucleating agent to form a mixture, wherein the mixture comprises about 90% to about 99% by weight of the compostable polymeric material;
melting the mixture;
extruding the molten mixture into an extrudate; and
cooling the extrudate at a predetermined cooling rate to form the compostable material, the predetermined cooling rate being faster than a rate at which the extrudate cools when subjected to room temperature conditions;
wherein the compostable material has a degree of crystallinity of about 5% to about 45%.

13. The method of claim 12, wherein the compostable material is a sheet.

14. The method of claim 12, wherein the compostable material is a tray.

15. The method of claim 12, further comprising thermoforming the extrudate to form the compostable material.

16. A method of forming a compostable material, comprising:
mixing a first compostable polymeric material and a nucleating agent to form a first mixture, the first compostable polymeric material having a degree of crystallinity of greater than 30%;
mixing the first mixture and a second compostable polymeric material to form a second mixture, the second compostable polymeric material having a degree of crystallinity of about 15% to about 45%;
melting the second mixture;
extruding the molten second mixture to form an extrudate; and
cooling the extrudate to form the compostable material;
wherein the compostable material has a degree of crystallinity of about 5% to about 30%.

17. The method of claim 16, wherein the second compostable polymeric material has a degree of crystallinity of about 35% to about 45%.

18. The method of claim 16, wherein the second compostable polymeric material has a degree of crystallinity that is greater than the degree of crystallinity of the first compostable polymeric material.

19. The method of claim 16, wherein the second compostable polymeric material comprises the first compostable polymeric material and the nucleating agent.

20. The method of claim 16, wherein the second compostable polymeric material comprises an extrudate, a thermoformed material, or combinations thereof.
